(19) United States
(12) Patent Application Publication
(10) Pub. No.: US 2016/0159659 A1
(43) Pub. Date: Jun. 9, 2016

(54) ANION-CONDUCTING MATERIAL AND METHOD FOR MANUFACTURING SAME

(71) Applicant: NORITAKE CO., LIMITED, Aichi (JP)

(72) Inventors: Peilin ZHANG, Nagoya-shi (JP); G.M. ANILKUMAR, Nagoya-shi (JP); Keita MIYAJIMA, Nagoya-shi (JP); Kaoruko KATO, Nagoya-shi (JP)

(73) Assignee: NORITAKE CO., LIMITED, Nagoya-shi, Aichi (JP)

(21) Appl. No.: 14/906,466

(22) PCT Filed: Jul. 2, 2014
(86) PCT No.: PCT/JP2014/067721

§ 371 Date: Jan. 20, 2016

(30) Foreign Application Priority Data
Jul. 25, 2013 (JP) 2013-155054

(51) Int. Cl. C01F 7/02; H01M 8/1016; H01M 4/86; C01F 7/66

(52) U.S. Cl. CPC C01F 7/02; C01F 7/66; H01M 8/1016; H01M 4/86; C01P 2002/22; C01P 2002/72

(57) ABSTRACT

An anion conductive material consists of a low-regularity layered double hydroxide having ion conductivity enhanced by delamination of a layer structure of a regular layered double hydroxide.

### TECHNICAL FIELD

The present invention relates to an anion conductive material consisting of a low-regularity layered double hydroxide having ion conductivity enhanced by delamination of a layer structure of a regular layered double hydroxide and a method of producing the same.

### BACKGROUND ART

For example, as described in Patent Documents 1 and 2, an inorganic type layered double hydroxide excellent in heat resistance and durability is used as an anion conductive material in some cases. Such an anion conductive material is used for electrolyte films and electrodes for fuel cells, for example. The layered double hydroxide is made up of, for example, a base layer [M²⁺₁₋ₓM³⁺ₓ(OH)₂]^{x+} and an intermediate layer [Aⁿ⁻_{x/n}.yH₂O]^{x-} stacked in a layered state and is represented by a common chemical formula [M²⁺₁₋ₓM³⁺ₓ(OH)₂]^{x+}[Aⁿ⁻_{x/n}.yH₂O]^{x-}. In this formula, M²⁺ is a divalent metal ion, M³⁺ is a trivalent metal ion, Anⁿ⁻ is a monovalent or divalent anion, x is a number within a range of 0.1 to 0.8, and y is a real number.

### PRIOR ART DOCUMENT

### Patent Documents

Patent Document 1: WO 2010/109670

Patent Document 2: Japanese Laid-Open Patent Publication No. 2010-113889

### SUMMARY OF THE INVENTION

### Problem to Be Solved by the Invention

With regard to the layered double hydroxide used for the anion conductive material, it is known from literature etc. that the ion conductivity of layered double hydroxide powder is significantly affected by a particle size of the layered double hydroxide and, as compared to the internal (interlayer) ion conductivity of particles of the layered double hydroxide, the ion conductivity of surfaces of the particles makes a larger contribution. Therefore, in the case of particles of a layered double hydroxide with a layer structure having relatively high regularity, i.e., a regular layered double hydroxide, acquired by a normal synthetic method, an ion conduction channel is a portion exhibiting a relatively high ion conductivity and is limited to the surfaces of the particles and, therefore, an anion conductive material consisting of the regular layered double hydroxide may have an insufficient ion conductivity. Additionally, the particles of the layered double hydroxide are disadvantageous in that the ion conductivity is drastically reduced at lower environmental humidity because water adsorbed on the particle surfaces is separated.

The present invention was conceived in view of the situations and it is therefore an object of the present invention to provide an anion conductive material having a high ion conductivity at low humidity as compared to conventional materials and a method of producing the same.

### Means for Solving the Problem

As a result of various analyses and studies, the present inventor found the following fact. Specifically, the present inventor found an unexpected fact that ion conductivity is enhanced by delaminating a layer structure of a regular layered double hydroxide with a layer structure having relatively high regularity and thereby collapsing the structure of the layered double hydroxide. The present invention was conceived based on such knowledge.

To achieve the above object, the principle of the present invention provides an anion conductive material consisting of a low-regularity layered double hydroxide having ion conductivity enhanced by delamination of a layer structure of a regular layered double hydroxide.

### Effects of the Invention

According to the anion conductive material of the principle of the present invention, since the anion conductive material consists of the low-regularity layered double hydroxide having the ion conductivity made higher by the delamination of the layer structure of the regular layered double hydroxide, the ion conductivity is higher as compared to the conventional anion conductive material consisting of the regular layered double hydroxide, and a reduction in the ion conductivity is prevented even at low humidity.

In one preferred form of the invention, the regular layered double hydroxide is a layered double hydroxide intercalated with nitrate ions, i.e., a layered double hydroxide having nitrate ions inserted through charge transfer into the intermediate layer of the layer structure of the regular layered double hydroxide. Therefore, the delamination of the regular layered double hydroxide can preferably be performed as compared to the regular layered double hydroxide intercalated with carbonate ions, for example.

In another preferred form of the invention, the delamination of the regular layered double hydroxide is performed by using formamide. Therefore, since formamide has a relatively large polarity and is used for the delamination of the regular layered double hydroxide, the delamination of the regular layered double hydroxide can preferably be performed.

In a further preferred form of the invention, the delamination of the regular layered double hydroxide is performed under the atmosphere. Therefore, with regard to the delamination of the regular layered double hydroxide, equipment for performing the delamination of the regular layered double hydroxide is simplified as compared to delamination performed under inert gas, for example.

In another preferred form of the invention, (a) the delamination of the regular layered double hydroxide is performed by putting and stirring the regular layered double hydroxide in formamide, and (b) the low-regularity layered double hydroxide after the delamination is collected through filtration or freeze-drying from formamide Therefore, for example, heating at high temperature for collecting the low-regularity layered double hydroxide is avoided and, thus, the reconstruction of the layer structure of the low-regularity layered double hydroxide due to the heating at high temperature can preferably be reduced.

In a further preferred form of the invention, the anion conductive material is used for preparation of an electrolyte film or an electrode for an alkaline fuel cell. Since the anion conductive material has relatively high ion conductivity at low humidity, the necessity for strict humidification control is eliminated as compared to the conventional cases when the anion conductive material is used as the electrolyte film or the electrode for the alkaline fuel cell.

In another preferred form of the invention, the anion conductive material is produced by a method comprising: (a) a delamination step of putting and stirring the regular layered double hydroxide in a predetermined amount of a reaction solvent; (b) a filtration step of filtrating a dispersion liquid of the low-regularity layered double hydroxide dispersed at the delamination step to collect the low-regularity layered double hydroxide; and (c) a drying step of drying the low-regularity layered double hydroxide acquired at the filtration step.

According to the method of producing the anion conductive material, the regular layered double hydroxide is put and stirred in a predetermined amount of the reaction solvent at the delamination step; the dispersion liquid in which the low-regularity layered double hydroxide dispersed at the delamination step is filtrated at the filtration step to collect the low-regularity layered double hydroxide; the low-regularity layered double hydroxide acquired at the filtration step is dried at the drying step to acquire the anion conductive material consisting of the low-regularity layered double hydroxide; and, as a result, the anion conductive material is produced that has higher ion conductivity at low humidity as compared to the conventional anion conductive material consisting of the regular layered double hydroxide.

In a further preferred form of the invention, the regular layered double hydroxide in the delamination step is a layered double hydroxide intercalated with nitrate ions, i.e., a layered double hydroxide having nitrate ions inserted through charge transfer into the intermediate layer of the layer structure of the regular layered double hydroxide. Therefore, the delamination of the regular layered double hydroxide can preferably be performed at the delamination step as compared to those intercalated with carbonate ions, for example.

In another preferred form of the invention, the reaction solvent is formamide. Therefore, since formamide is the reaction solvent having a relatively large polarity and is used for the delamination of the regular layered double hydroxide at the delamination step, the delamination of the regular layered double hydroxide can preferably be performed.

In a further preferred form of the invention, the delamination step is performed under the atmosphere. Therefore, at the delamination step, equipment for performing the delamination of the regular layered double hydroxide is simplified as compared to delamination performed under inert gas, for example.

In another preferred form of the invention, the drying step is performed by freeze-drying. Therefore, for example, heating at high temperature is avoided at the drying step and, thus, the reconstruction of the layer structure of the low-regularity layered double hydroxide due to the heating at high temperature can preferably be reduced.

### BRIEF DESCRIPTION OF THE DRAWINGS

FIG. 1 is a schematic cross sectional view of a configuration of an alkaline fuel cell including an electrolyte film consisting of an anion conductive material of an example of the present invention.

FIG. 2 is a schematic cross-sectional view of a structure of a layered double hydroxide in the anion conductive material used for the electrolyte film of FIG. 1.

FIG. 3 is a flowchart for explaining production steps of a regular layered double hydroxide that is a state before delamination into a low-regularity layered double hydroxide in the anion conductive material used for the electrolyte film of FIG. 1.

FIG. 4 is a flowchart for explaining production steps of the anion conductive material consisting of the low-regularity layered double hydroxide used for the electrolyte film of FIG. 1.

FIG. 5 is a diagram of X-ray diffraction patterns of anion conductive materials measured by a powder X-ray diffractometry for examining crystal structures of an anion conductive material of an example product 1 consisting of the low-regularity layered double hydroxide produced by the production steps shown in FIGS. 3 and 4, anion conductive materials of comparison example products 1, 2 consisting of the regular layered double hydroxide produced by the production step shown in FIG. 3, etc.

FIG. 6 is a schematic diagram of a measurement method of measuring ion conductivity of anion conductive material with respect to the anion conductive materials of the example product 1 and the comparison example products 1 to 5 shown in FIG. 5.

FIG. 7 is a diagram of the ion conductivity of the anion conductive materials of the example product 1 and the comparison example products 1 to 5 shown in FIG. 5 at the relative humidity of 80%, 50%, and 20% at the temperature of 80 degrees.

FIG. 8 is a diagram of a line graph of the ion conductivity of the anion conductive material of the comparison example product 1 and the anion conductive material of the comparison example product 2 at the relative humidity of 80%, 50%, and 20% at the temperature of 80 degrees.

FIG. 9 is a diagram of a line graph of the ion conductivity of the anion conductive material of the example product 1 and the anion conductive material of the comparison example product 2 at the relative humidity of 80%, 50%, and 20% at the temperature of 80 degrees.

FIG. 10 is a diagram of a line graph of the ion conductivity of the anion conductive material of the comparison example product 2 and the anion conductive material of the comparison example product 3 at the relative humidity of 80%, 50%, and 20% at the temperature of 80 degrees.

FIG. 11 is a diagram of a line graph of the ion conductivity of the anion conductive material of the comparison example product 2 and the anion conductive material of the comparison example product 4 at the relative humidity of 80%, 50%, and 20% at the temperature of 80 degrees.

FIG. 12 is a diagram of a line graph of the ion conductivity of the anion conductive material of the comparison example product 2 and the anion conductive material of the comparison example product 5 at the relative humidity of 80%, 50%, and 20% at the temperature of 80 degrees.

### MODE FOR CARRYING OUT THE INVENTION

An example of the present invention will now be described in detail with reference to the drawings. In the following example, the figures are simplified or deformed as needed and portions are not necessarily precisely shown in terms of dimension ratio, shape, etc.

### Example 1

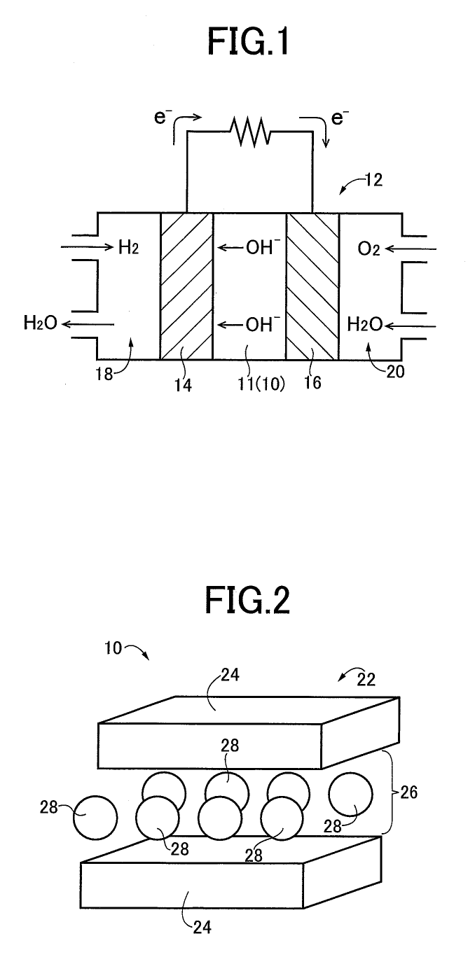

FIG. 1 is a schematic cross sectional view of a configuration of an alkaline fuel cell 12 including an electrolyte film 11 using an anion conductive material 10 of an example of the present invention. As shown in FIG. 1, the alkaline fuel cell 12 has a structure in which an anode (fuel electrode) 14 and a cathode (air electrode) 16 having electric conductivity and gas permeability are made of carbon cloth supporting catalyst-carrying carbon carrying platinum, transition metal, etc., on one entire surface facing the electrolyte film 11 and face each other via the electrolyte film 11. The alkaline fuel cell 12 is provided with a fuel chamber 18 on the side of the anode 14 not in contact with the electrolyte film 11 and an oxidizer gas chamber 20 on the side of the cathode 16 not in contact with the electrolyte film 11, and the fuel chamber 18 is supplied with a hydrogen gas (H₂), for example, while the oxidizer gas chamber 20 is supplied with a gas (air) etc. containing oxygen (O₂), for example. The electrolyte film 11 is formed by, for example, cold press of the anion conductive material 10.

In the alkaline fuel cell 12 configured as described above, when current is applied to the alkaline fuel cell 12, the oxygen in the oxygen-containing gas reacts with water (H₂O) in the cathode 16 to generate hydroxide ions (OH⁻), and the generated hydroxide ions are supplied from the cathode 16 through the electrolyte film 11 to the anode 14. The hydroxide ions react with a fuel in the anode 14 to generate water and emit electrons (e⁻), thereby generating electricity.

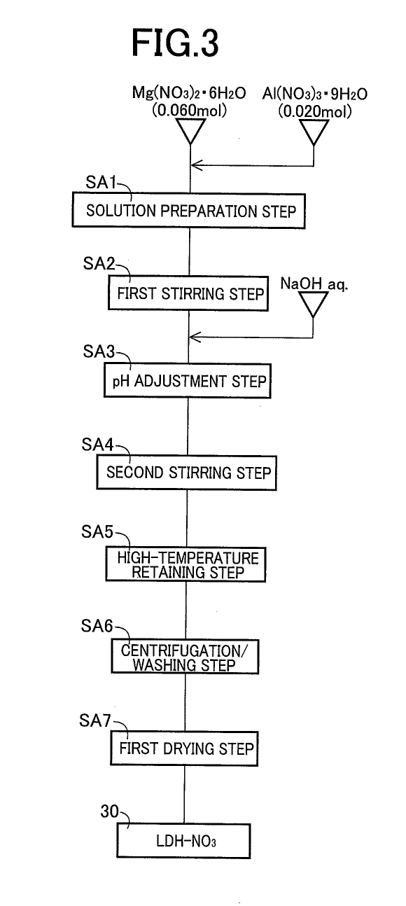

The anion conductive material 10 used for the electrolyte film 11 consists of a layered double hydroxide 22 and FIG. 2 is a schematic cross-sectional view of a layer structure of the layered double hydroxide 22. As shown in FIG. 2, the layered double hydroxide 22 is made up of a plurality of base layers 24 having divalent or trivalent cations, for example, magnesium ions (Mg²⁺) or aluminum ions (Al³⁺) present at random surrounded by hydroxide ions (OH⁻), and an intermediate layer 26 consisting of anions 28, for example, nitrate ions (NO₃⁻) and water molecules, not shown, present between layers of a plurality of the base layers 24. The layered double hydroxide 22 of the anion conductive material 10 of this example is a low-regularity layered double hydroxide 22 with a layer structure having relatively low regularity because the regularity of the layer structure is disturbed by performing delamination through a delamination step SB1 described later to collapse a layer structure of a regular layered double hydroxide 30 (see FIG. 3) with a layer structure having relatively high regularity in which the base layers 24 and the intermediate layer 26 are stacked in a regular manner in the layer structure. In this example, the base layer 24 is represented by [Mg²⁺₁₋ₓAl³⁺ₓ(OH)₂]^{x+}, for example, and the intermediate layer 26 is represented by [NO₃⁻ₓ.yH₂O]^{x-}, for example.

FIG. 3 is a flowchart for explaining production steps SA1 to SA7 of the regular layered double hydroxide 30 described above. As shown in FIG. 3, first, at a solution preparation step SA1, for example, 150 g of solution is prepared by dissolving 15.384 g (0.060 mol) of magnesium nitrate hexahydrate (Mg(NO₃)₂.6H₂O) and 7.502 g (0.020 mol) of aluminum nitrate nonahydrate (Al(NO₃)₃.9H₂O) in purified water.

At a first stirring step SA2, the solution acquired at the solution preparation step SA1 is stirred for 20 minutes. At a pH adjustment step SA3, a 4 M sodium hydroxide (NaOH) solution is added to the solution stirred at the first stirring step SA2 to adjust pH of the solution to 9.5, for example. It is noted that at the pH adjustment step SA3, the 4 M sodium hydroxide solution is continuously added until the pH of the solution becomes stable at 9.5. At a second stirring step SA4, the solution adjusted to pH of 9.5 at the pH adjustment step SA3 is stirred for 30 minutes.

At a high-temperature retaining step SA5, a beaker containing the solution stirred at the second stirring step SA4 is covered with a watch glass and further lightly wrapped by a wrap and is retained in an electric oven for 4 hours at 80 degrees, for example.

At a centrifugation/washing step SA6, the solution acquired at the high-temperature retaining step SA5 is centrifuged to collect a precipitate of the solution, and the collected precipitate is washed with purified water thrice, for example.

At a first drying step SA7, the precipitate collected and washed at the centrifugation/washing step SA6 is dried overnight at 80 degrees, for example. As a result, the regular layered double hydroxide 30 is acquired. The regular layered double hydroxide 30 produced through the solution preparation step SA1 to the first drying step SA7 is a layered double hydroxide intercalated with nitrate ions (NO₃⁻), i.e., a regular layered double hydroxide having nitrate ions (NO₃⁻) inserted through charge transfer into the intermediate layer 26 of the layer structure of the regular layered double hydroxide 30.

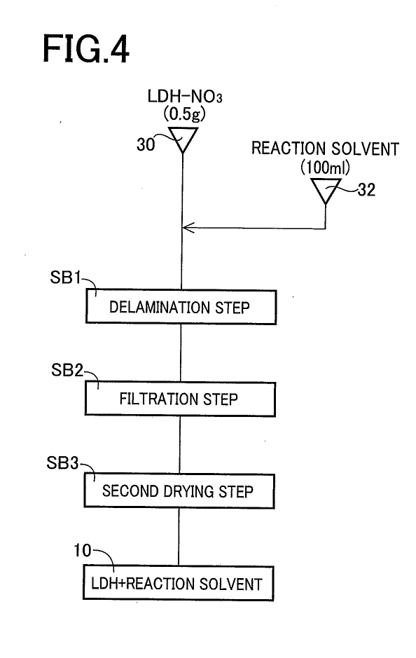

FIG. 4 is a flowchart for explaining production steps SB1 to SB3 of the anion conductive material 10 consisting of the low-regularity layered double hydroxide 22 formed by delamination of the layer structure of the regular layered double hydroxide 30 described above. As shown in FIG. 4, first, at a delamination step SB1, a solution is acquired by putting 0.5 g of the regular layered double hydroxide 30 described above into 100 ml of a reaction solvent 32, for example, formamide, and is sealed in, for example, a container under the atmosphere without using inert gases, and the solution is stirred at room temperature for 6 hours, for example. At this delamination step SB1, the layer structure of the regular layered double hydroxide 30 is delaminated to generate the low-regularity layered double hydroxide 22 in the formamide that is the reaction solvent 32.

At a filtration step SB2, a dispersion liquid of the low-regularity layered double hydroxide 22 dispersed in the reaction solvent 32 at the delamination step SB 1 is subjected to suction filtration to collect the low-regularity layered double hydroxide 22 from the formamide that is the reaction solvent 32.

At a second drying step (drying step) SB3, the low-regularity layered double hydroxide 22 collected at the filtration step SB2 from the formamide used as the reaction solvent 32 is dried overnight at 80 degrees, for example. It is noted that at the second drying step SB3, the low-regularity layered double hydroxide 22 collected from the reaction solvent 32 at the filtration step SB2 may be dried by freeze-drying. As a result, the anion conductive material 10 consisting of the low-regularity layered double hydroxide 22 is acquired.

### Experiment I

An experiment I conducted by the present inventors will be described. This experiment I is an experiment for verifying that the delamination step SB1 described above causes the delamination of the layer structure of the regular layered double hydroxide 30 to generate the low-regularity layered double hydroxide 22.

In this experiment I, first, the anion conductive material 10 of an example product 1 (LDH+FMD) was produced through the solution preparation step SA1 to the first drying step SA7 and the delamination step SB1 to the second drying step SB3 described above, and crystal structure of the powdered anion conductive material 10 was examined by the powder X-ray diffractometry. The “LDH+FMD” is a code indicative of the use of formamide (FMD) as the reaction solvent 32 for the delamination of the regular layered double hydroxide (LDH) 30 in the anion conductive material 10. Also in the experiment I, the anion conductive materials 10 of a comparison example product 1 (LDH-CO₃) and a comparison example product 2 (LDH-NO₃) were produced through the solution preparation step SA1 to the first drying step SA7 described above, i.e., the anion conductive materials 10 consisting of the regular layered double hydroxide 30 were produced without performing the delamination step SB1 to the second drying step SB3, and crystal structures of the powdered anion conductive materials 10 were examined by the powder X-ray diffractometry in the same way as above. The anion conductive material 10 of the comparison example product 1 is different from the anion conductive material 10 of the comparison example product 2 in that the material is produced by adding and stirring 100 g of a solution prepared by dissolving 2.120 g of sodium carbonate (Na₂CO₃) in purified water at the first stirring step SA2 described above. The “LDH-CO₃” is a code indicative of the intercalation of carbonate ions (CO₃²⁻) in the regular layered double hydroxide (LDH) 30 that is the anion conductive material 10 of the comparison example product 1, and the “LDH-NO₃” is a code indicative of the intercalation of nitrate ions (NO₃⁻) in the regular layered double hydroxide (LDH) 30 that is the anion conductive material 10 of the comparison example product 2.

Also in the experiment I, the reaction solvents 32 other than formamide, i.e., acetylamide, N,N-dimethylformamide, and N-methylpyrrolidone, were used as the reaction solvents 32 used for the regular layered double hydroxide 30 at the delamination step SB1 described above to produce the anion conductive material 10 of a comparison example product 3 (LDH+AAM), the anion conductive material 10 of a comparison example product 4 (LDH+DMF), and the anion conductive material 10 of a comparison example product 5 (LDH+NMP) through the solution preparation step SA1 to the first drying step SA7 and the delamination step SB1 to the second drying step SB3, and crystal structures of the powdered anion conductive materials 10 were examined by the powder X-ray diffractometry in the same way as above. The “LDH+AAD” is a code indicative of the use of acetylamide (AAD) as the reaction solvent 32 for the delamination of the regular layered double hydroxide (LDH) 30 at the delamination step SB1, the “LDH+DMF” is a code indicative of the use of N,N-dimethylformamide (DMF) as the reaction solvent 32 for the delamination of the regular layered double hydroxide (LDH) 30 at the delamination step SB1, and the “LDH+NMP” is a code indicative of the use of N-methylpyrrolidone (NMP) as the reaction solvent 32 for the delamination of the regular layered double hydroxide (LDH) 30 at the delamination step SB1.

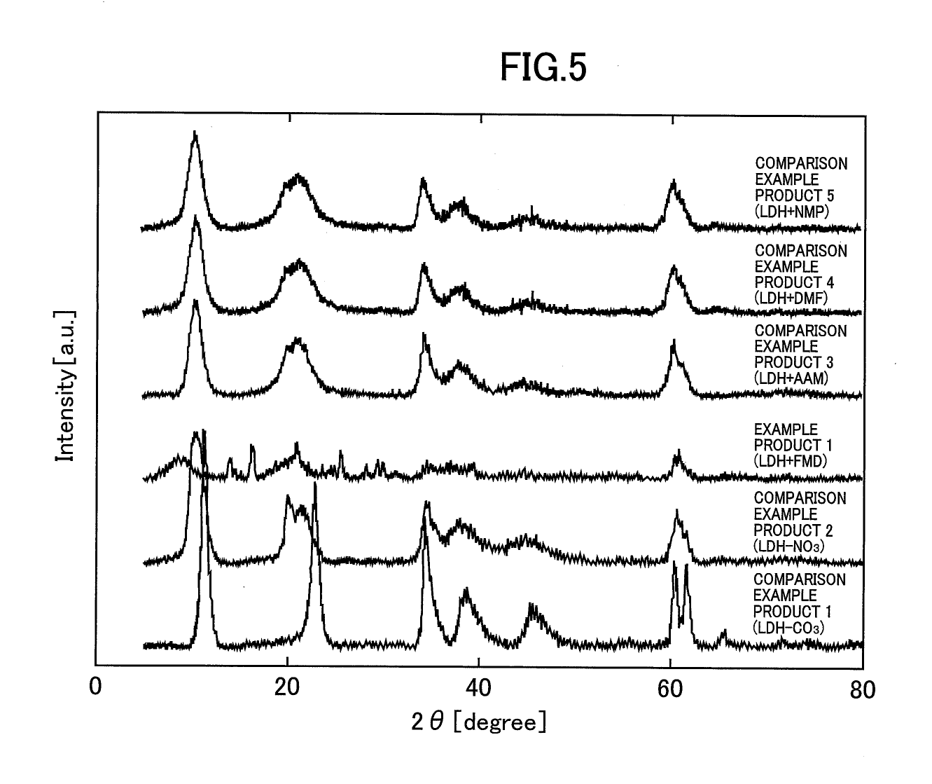

The result of the experiment I will hereinafter be described with reference to FIG. 5. As shown in FIG. 5, the anion conductive material 10 of the comparison example product 1 has a sharp diffraction peak observed near 10 degrees, which indicates that the anion conductive material 10 of the comparison example product 1 consists of the regular layered double hydroxide 30 with a layer structure having relatively high regularity. The anion conductive material 10 of the comparison example product 2 has a diffraction peak observed near 10 degrees, which indicates that the anion conductive material 10 of the comparison example product 2 consists of the regular layered double hydroxide 30 with a layer structure having relatively high regularity. It is noted that the anion conductive material 10 of the comparison example product 2 has the diffraction peak near 10 degrees with a peak width larger than that of the anion conductive material 10 of the comparison example product 1, which indicates reductions in particle diameter and the regularity of the layer structure of the layered double hydroxide. The anion conductive material 10 of the example product 1 has almost no strong peak observed near 10 degrees as compared to the anion conductive material 10 of the comparison example product 1 and the anion conductive material 10 of the comparison example product 2. Therefore, it is considered that the layer structure of the regular layered double hydroxide 30 is collapsed by delamination of the layer structure of the regular layered double hydroxide 30 in the anion conductive material 10 of the example product 1. The anion conductive materials 10 of the comparison example products 3 to 5 have substantially the same diffraction patterns as the anion conductive material 10 of the comparison example product 2, which indicates that the anion conductive materials 10 of the comparison example products 3 to 5 have the layer structures with relatively high regularity as is the case with the anion conductive material 10 of the comparison example product 2. Therefore, it is revealed that using acetylamide, N,N-dimethylformamide, and N-methylpyrrolidone as the reaction solvent 32 has almost no effect on the delamination of the regular layered double hydroxide 30 at the delamination step SB1.

According to the result of the experiment I of FIG. 5, the anion conductive materials 10 of the comparison example products 1, 2 have a strong peak observed near 10 degrees; however, the anion conductive material 10 of the example product 1 has almost no strong peak observed near 10 degrees. It is therefore considered that the delamination step SB1 causes the delamination of the layer structure of the regular layered double hydroxide 30 and the collapse of the layer structure to generate the low-regularity layered double hydroxide 22.

According to the result of the experiment I of FIG. 5, the anion conductive material 10 of the example product 1 has almost no strong peak observed near 10 degrees; however, the anion conductive materials 10 of the comparison example products 3 to 5 have a strong peak observed near 10 degrees. It is therefore considered that the delamination of the regular layered double hydroxide 30 can preferably be performed by using formamide as the reaction solvent 32 at the delamination step SB 1.

According to the result of the experiment I of FIG. 5, the anion conductive material 10 of the comparison example product 2 has the peak width of the diffraction peak near 10 degrees larger than that of the anion conductive material 10 of the comparison example product 1, which indicates the reductions in the particle diameter and the regularity of the layer structure of the layered double hydroxide. Therefore, it is considered that the delamination of the regular layered double hydroxide 30 can preferably be performed in the regular layered double hydroxide 30 intercalated with nitrate ions (NO₃⁻) as compared to the regular layered double hydroxide 30 intercalated with carbonate ions (CO₃²⁻).

### Experiment II

An experiment II conducted by the present inventors will be described. This experiment II is an experiment for verifying that an ion conductivity is enhanced in the anion conductive material 10 consisting of the low-regularity layered double hydroxide 22 with a layer structure having relatively low regularity acquired by delaminating the regular layered double hydroxide 30 and thereby collapsing the layer structure thereof, as compared to the anion conductive material 10 consisting of the regular layered double hydroxide 30.

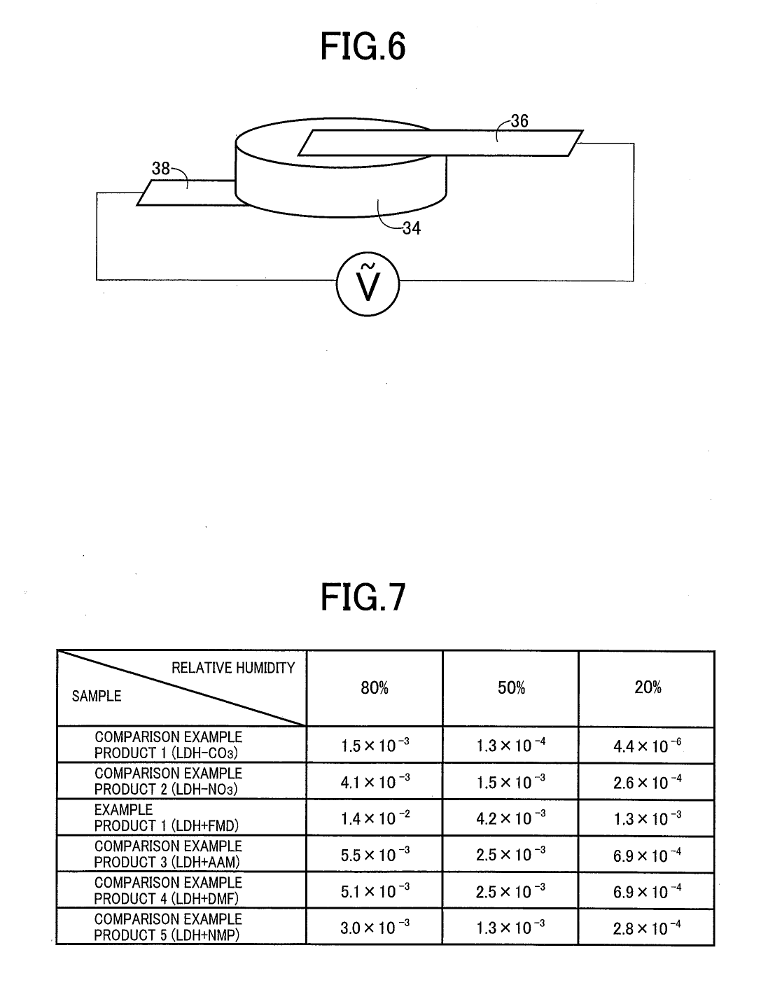

In the experiment II, the respective powders of the anion conductive materials 10 of the example product 1 and the comparison example products 1 to 5 were used for preparing six types of pellets 34 formed into, for example, a diameter of 10 mm and a thickness of 1.5 mm by uniaxial pressing of the powders. Therefore, the produced pellets 34 were the pellet 34 using the anion conductive material 10 of the example product 1, the pellet 34 using the anion conductive material 10 of the comparison example product 1, the pellet 34 using the anion conductive material 10 of the comparison example product 2, the pellet 34 using the anion conductive material 10 of the comparison example product 3, the pellet 34 using the anion conductive material 10 of the comparison example product 4, and the pellet 34 using the anion conductive material 10 of the comparison example product 5. Subsequently, as shown in FIG. 6, a silver paste is applied onto both surfaces of the prepared pellets 34 and a pair of gold electrodes 36 and 38 was attached to the silver paste on the both surfaces of the pellets 34. The ion conductivity of each of the six types of the pellets 34 was measured by an AC impedance analyzing method at the relative humidity of 80%, 50%, and 20% when an environmental temperature is 80 degrees. In the experiment II, the environment control of the pellets 34 was provided by using a small environment tester of SH-221 manufactured by ESPEC (Japan), and the ion conductivity of the pellets 34 was measured by using an electric characteristic evaluation device of Solartron 1260 Impedance/gain-phase analyzer manufactured by Solartron Analytical (UK).

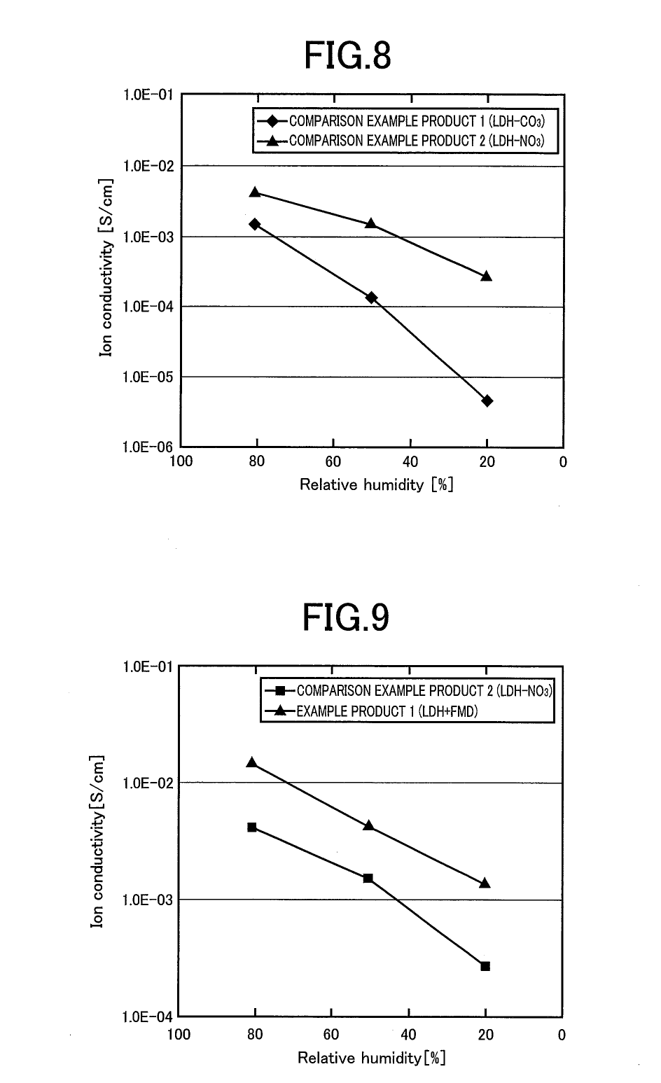

The result of the experiment II will hereinafter be described with reference to FIGS. 7 to 12. As depicted in FIG. 7, the pellet 34 using the anion conductive material 10 of the example product 1 exhibits the ion conductivity that is 9 or more times as large as the pellet 34 using the anion conductive material 10 of the comparison example product 1 consisting of the regular layered double hydroxide 30 before delamination, at all the humidity environments, i.e., at the relative humidity of 80%, 50%, and 20%. As shown in FIGS. 7 and 9, the pellet 34 using the anion conductive material 10 of the example product 1 exhibits the ion conductivity that is 2 to 5 times as large as the pellet 34 using the anion conductive material 10 of the comparison example product 2 consisting of the regular layered double hydroxide 30 before delamination. As shown in FIGS. 7 and 8, the pellet 34 using the anion conductive material 10 of the comparison example product 2 exhibits higher ion conductivity at all the humidity environments as compared to the pellet 34 using the anion conductive material 10 of the comparison example product 1.

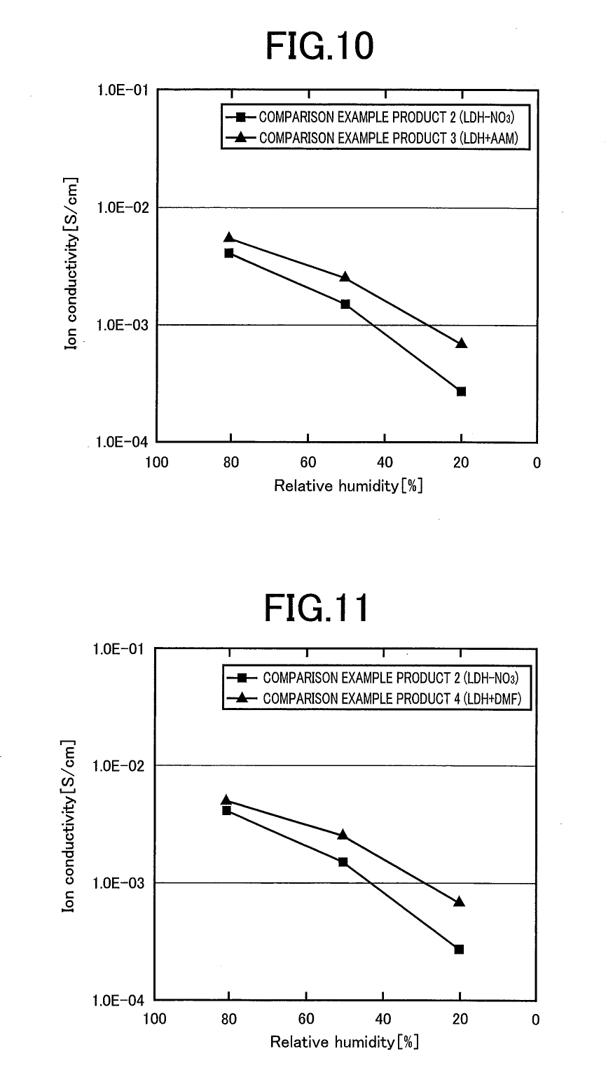

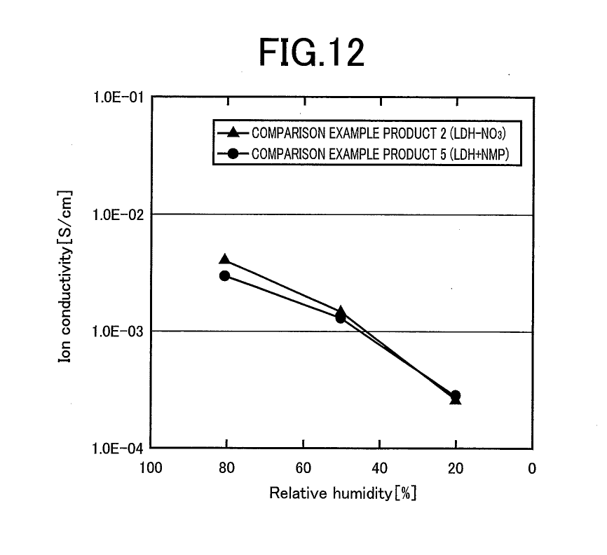

As shown in FIGS. 7 and 10, the pellet 34 using the anion conductive material 10 of the comparison example product 3 exhibits higher ion conductivity at all the humidity environments as compared to the pellet 34 using the anion conductive material 10 of the comparison example product 2. However, the difference in the ion conductivity between these pellets 34 is smaller than the difference between the ion conductivity of the pellet 34 using the anion conductive material 10 of the example product 1 and the ion conductivity of the pellet 34 using the anion conductive material 10 of the comparison example product 2. As shown in FIGS. 7 and 11, the pellet 34 using the anion conductive material 10 of the comparison example product 4 exhibits higher ion conductivity at all the humidity environments as compared to the pellet 34 using the anion conductive material 10 of the comparison example product 2. However, the difference in the ion conductivity between these pellets 34 is smaller than the difference between the ion conductivity of the pellet 34 using the anion conductive material 10 of the example product 1 and the ion conductivity of the pellet 34 using the anion conductive material 10 of the comparison example product 2. As shown in FIGS. 7 and 12, the pellet 34 using the anion conductive material 10 of the comparison example product 5 exhibits higher ion conductivity at the relative humidity of 20% and lower ion conductivity at the relative humidity of 80% and 50% as compared to the pellet 34 using the anion conductive material 10 of the comparison example product 2.

According to the result of the experiment II of FIGS. 7 to 12, the pellet 34 using the anion conductive material 10 of the example product 1 consisting of the low-regularity layered double hydroxide 22 acquired through delamination of the layer structure of the regular layered double hydroxide 30 has higher ion conductivity at the relative humidity of 80%, 50%, and 20% as compared to the pellets 34 using the anion conductive materials 10 of the comparison example products 1 and 2 consisting of the regular layered double hydroxide 30. It is therefore considered that the ion conductivity is made higher in the low-regularity layered double hydroxide 22 acquired through delamination of the layer structure of the regular layered double hydroxide 30, as compared to the regular layered double hydroxide 30, and that the ion conductivity is made higher in the anion conductive material 10 consisting of the low-regularity layered double hydroxide 22 having the higher ion conductivity, as compared to the anion conductive material 10 consisting of the regular layered double hydroxide 30. It is also considered that even at low humidity when the relative humidity is 20%, the ion conductivity is higher in the low-regularity layered double hydroxide 22 as compared to the regular layered double hydroxide 30.

According to the anion conductive material 10 of the example product 1 of this example, since the anion conductive material 10 consists of the low-regularity layered double hydroxide 22 having the ion conductivity made higher by the delamination of the layer structure of the regular layered double hydroxide 30, the ion conductivity is higher as compared to the anion conductive material 10 consisting of the regular layered double hydroxide 30 such as the anion conductive material 10 of the comparison example product 1, for example, and a reduction in the ion conductivity is prevented even at low humidity.

According to the anion conductive material 10 of the example product 1 of this example, the regular layered double hydroxide 30 is a layered double hydroxide intercalated with nitrate ions, i.e., a layered double hydroxide having nitrate ions inserted through charge transfer into the intermediate layer 26 of the layer structure of the regular layered double hydroxide 30. Therefore, the delamination of the regular layered double hydroxide 30 can preferably be performed as compared to the regular layered double hydroxide 30 intercalated with carbonate ions, for example.

According to the anion conductive material 10 of the example product 1 of this example, the delamination of the regular layered double hydroxide 30 is performed by using formamide. Therefore, since formamide has a relatively large polarity and is used for the delamination of the regular layered double hydroxide 30, the delamination of the regular layered double hydroxide 30 can preferably be performed.

According to the anion conductive material 10 of the example product 1 of this example, the delamination of the regular layered double hydroxide 30 is performed under the atmosphere. Therefore, with regard to the delamination of the regular layered double hydroxide 30, equipment for performing the delamination of the regular layered double hydroxide 30 is simplified as compared to delamination performed under inert gas, for example.

According to the anion conductive material 10 of the example product 1 of this example, the delamination of the regular layered double hydroxide 30 is performed by putting and stirring the regular layered double hydroxide 30 in formamide, and the low-regularity layered double hydroxide 22 after the delamination is collected through filtration or freeze-drying from formamide. Therefore, for example, heating at high temperature for collecting the low-regularity layered double hydroxide 22 is avoided and, thus, the reconstruction of the layer structure of the low-regularity layered double hydroxide 22 due to the heating at high temperature can preferably be reduced.

According to the anion conductive material 10 of the example product 1 of this example, the anion conductive material 10 is used for preparation of the electrolyte film 10 for the alkaline fuel cell 12. Since the anion conductive material 10 consisting of the low-regularity layered double hydroxide 22 has relatively high ion conductivity at low humidity, the necessity for strict humidification control is eliminated as compared to the conventional cases when the anion conductive material 10 is used as the electrolyte film 10 for the alkaline fuel cell 12.

According to a method of producing the anion conductive material 10 of the example product 1 of this example, the regular layered double hydroxide 30 is put and stirred in a predetermined amount of the reaction solvent 32 at the delamination step SB1; the dispersion liquid in which the low-regularity layered double hydroxide 22 dispersed at the delamination step SB 1 is filtrated at the filtration step SB2 to collect the low-regularity layered double hydroxide 22; the low-regularity layered double hydroxide 22 acquired at the filtration step SB2 is dried at the second drying step SB3 to acquire the anion conductive material 10 of the example product 1 consisting of the low-regularity layered double hydroxide 22; and, as a result, the anion conductive material 10 is produced that has higher ion conductivity at low humidity as compared to the conventional anion conductive material consisting of the regular layered double hydroxide 30, for example, the anion conductive material 10 of the comparison example product 2.

According to the method of producing the anion conductive material 10 of the example product 1 of this example, the regular layered double hydroxide 30 in the delamination step SB1 is a layered double hydroxide intercalated with nitrate ions, i.e., a layered double hydroxide having nitrate ions inserted through charge transfer into the intermediate layer 26 of the layer structure of the regular layered double hydroxide 30. Therefore, the delamination of the regular layered double hydroxide 30 can preferably be performed at the delamination step SB1 as compared to those intercalated with carbonate ions, for example.

According to the method of producing the anion conductive material 10 of the example product 1 of this example, the reaction solvent 32 used at the delamination step SB1 is formamide. Therefore, since formamide is the reaction solvent 32 having a relatively large polarity and is used for the delamination of the regular layered double hydroxide 30 at the delamination step SB1, the delamination of the regular layered double hydroxide 30 can preferably be performed.

According to the method of producing the anion conductive material 10 of the example product 1 of this example, the delamination step SB1 is performed under the atmosphere. Therefore, at the delamination step SB1, equipment for performing the delamination of the regular layered double hydroxide 30 is simplified as compared to delamination performed under inert gas, for example.

According to the method of producing the anion conductive material 10 of the example product 1 of this example, the second drying step SB3 is performed by freeze-drying. Therefore, for example, heating at high temperature is avoided at the second drying step SB3 and, thus, the reconstruction of the layer structure of the low-regularity layered double hydroxide 22 due to the heating at high temperature can preferably be reduced.

Although the examples of the present invention have been described in detail with reference to the drawings, the present invention is applied in other forms.

Although the base layers 24 of the layered double hydroxide 22 in the anion conductive material 10 of the example product 1 have magnesium ions (Mg²⁺) and aluminum ions (Al³⁺) as shown in FIG. 2, divalent metal ions other than the magnesium ions may be used instead of the magnesium ions, including ferrous ions (Fe²⁺), zinc ions (Zn²⁺), calcium ions (Ca²⁺), manganese ions (Mn²⁺), nickel ions (Ni²⁺), cobalt ions (Co²⁺), and copper ions (Cu²⁺), for example, and trivalent metal ions other than the aluminum ions may be used instead of the aluminum ions, including ferrous ions (Fe³⁺), manganese ions (Mn³⁺), and cobalt ions (Co³⁺), for example. The base layers 24 are not limited only to those having one type of divalent metal ions and one type of trivalent metal ions. For example, the base layers 24 may have one type of monovalent metal ions and one type of divalent metal ions or may have one type of divalent metal ions and two types of tetravalent metal ions. In particular, the base layers 24 may have one or more types for each of metal ions different in valence. Metal ions of the same element may be included if the metal ions are different in valence. Therefore, the layered double hydroxide 22 of this example may include two or more types of metal ions different in valence. Although the anion conductive material 10 of the example product 1 of this example has nitrate ions (NO₃⁻) in the intermediate layer 26 of the layered double hydroxide 22, anions other than nitrate ions may be used, including carbonate ions (CO₃²⁻), hydroxide ions (OH⁻), chloride ions (Cl⁻), and bromide ions (Br⁻), for example.

Although formamide with a large polarity is used as the reaction solvent 32 at the delamination step SB1 for the anion conductive material 10 of the example product 1 of this example, for example, the reaction solvent 32 other than formamide may be used, including dimethyl sulfoxide and methylformamide, for example. In particular, the reaction solvent 32 may be any reaction solvent capable of delamination of the layer structure of the regular layered double hydroxide 30.

Although the anion conductive material 10 consisting of the low-regularity layered double hydroxide 22 is used for the electrolyte film 10 of the alkaline fuel cell 12 in this example, the anion conductive material 10 may be used for other components for an alkaline fuel cell, for example, an electrode for an alkaline fuel cell. Since the anion conductive material 10 consisting of the low-regularity layered double hydroxide 22 of this example has relatively high ion conductivity at low humidity, if the anion conductive material 10 is used as an electrode for an alkaline fuel cell, the necessity for strict humidification control is eliminated as compared to the conventional cases.

The above description is merely an embodiment and the present invention may be implemented in variously modified and improved forms based on the knowledge of those skilled in the art.

### NOMENCLATURE OF ELEMENTS

10: anion conductive material

11: electrolyte film

12: alkaline fuel cell

22: layered double hydroxide

30: regular layered double hydroxide

32: reaction solvent

SB1: delamination step

SB2: filtration step

SB3: second drying step (drying step)

1. An anion conductive material consisting of a low-regularity layered double hydroxide having ion conductivity enhanced by delamination of a layer structure of a regular layered double hydroxide.

2. The anion conductive material according to claim 1, wherein the regular layered double hydroxide is a layered double hydroxide intercalated with nitrate ions.

3. The anion conductive material according to claim 1, wherein the delamination of the regular layered double hydroxide is performed by using formamide.

4. The anion conductive material according to claim 1, wherein the delamination of the regular layered double hydroxide is performed under the atmosphere.

5. The anion conductive material according to claim 1, wherein
the delamination of the regular layered double hydroxide is performed by putting and stirring the regular layered double hydroxide in formamide, and wherein
the low-regularity layered double hydroxide after the delamination is collected through filtration or freeze-drying from formamide.

6. An electrolyte film or an electrode for an alkaline fuel cell prepared by using the anion conductive material according to claim 1.

7. A method of producing the anion conductive material according to claim 1, the method comprising:
a delamination step of putting and stirring the regular layered double hydroxide in a predetermined amount of a reaction solvent;
a filtration step of filtrating a dispersion liquid of the low-regularity layered double hydroxide dispersed at the delamination step to collect the low-regularity layered double hydroxide; and
a drying step of drying the low-regularity layered double hydroxide acquired at the filtration step.

8. The method of producing the anion conductive material according to claim 7, wherein the regular layered double hydroxide in the delamination step is a layered double hydroxide intercalated with nitrate ions.

9. The method of producing the anion conductive material according to claim 7,, wherein the reaction solvent is formamide.

10. The method of producing the anion conductive material according to claim 9, wherein the delamination step is performed under the atmosphere.

11. The method of producing the anion conductive material according to claim 7, wherein the drying step is performed by freeze-drying.
